(19) United States
(12) Patent Application Publication
(10) Pub. No.: US 2026/0004597 A1
(43) Pub. Date: Jan. 1, 2026

(54) METHODS AND SYSTEMS FOR IMAGING INTERACTIONS BETWEEN PARTICLES AND FRAGMENTS

(71) Applicant: University of Massachusetts, Westborough, MA (US)

(72) Inventors: Benjamin A. Himes, Smithfield, RI (US); Bronwyn A. Lucas, Worcester, MA (US); Nikolaus Grigorieff, Worcester, MA (US)

(21) Appl. No.: 18/869,129

(22) PCT Filed: May 25, 2023
(86) PCT No.: PCT/US2023/067479

§ 371 Date: Nov. 25, 2024

Related U.S. Application Data
(60) Provisional application No. 63/365,465, filed on May 27, 2022.

(51) Int. Cl. G06V 20/69; G06V 20/64

(52) U.S. Cl. CPC G06V 20/69; G06V 20/653

(57) ABSTRACT

Methods and systems for imaging interactions between particles and fragments are provided. A method includes applying a template to one or more images of a sample comprising a particle and a fragment. The template comprises a three-dimensional representation of the particle at a resolution of higher than about ⅛ reciprocal Angstroms and is produced by data independent of data provided in the one or more images. The fragment is not represented in the template. A similarity image is produced comprising a pixel-wise representation of a distance metric between the template and the one or more images. The distance metric enables detection of at least a portion of the particle or fragment. A threshold is applied to the similarity image to distinguish positive detections from noise and a representation of a volume as a function of the positive detections is produced, representing an interaction between the particle and the fragment.

### RELATED APPLICATION(S)

This application claims the benefit of U.S. Provisional Application No. 63/365,465, filed on May 27, 2022. The entire teachings of the above application are incorporated herein by reference.

### BACKGROUND

Over the last decade, single-particle electron cryo-microscopy (cryo-EM) has emerged as a high-resolution technique to study molecules and their assemblies in solution. In the most favorable cases, close to 1 Angstrom resolution can be achieved, rivaling results obtained by protein crystallography. The resolution obtained from a single-particle dataset depends on the quality of the images, the accuracy of particle alignment parameters and other meta data describing the particles, as well as the number of particles contributing to a reconstruction. For a high-quality dataset, between 20,000 and 70,000 asymmetric units of well-aligned and homogeneous particles are be averaged to reach 2 Angstrom resolution.

Cryo-EM methods development has also succeeded in imaging particles in situ at high resolution using tomography and subtomogram averaging. These averages now approach 3 Angstrom resolution, a resolution obtained routinely for single-particle reconstructions. Data collection for tomography requires more time compared to the single-particle technique due to the need for tilt series, and processing tends to be computationally more expensive due to the 3D data format, compared to 2D images used in the single-particle technique. An additional complication of subtomogram averaging for in-situ imaging is the selection of valid targets, which are identified against a background of other molecules inside the cell or tissue being imaged. In a typical single-particle dataset, the particles have undergone a purification step that enriches the particle of interest, and the solvent background makes particle selection more reliable.

There exists a need for providing improved cryo-EM imaging processes.

### SUMMARY

Methods and systems for imaging interactions between particles and fragments are provided. Such methods and systems can advantageously provide for streamlined processing of high-resolution images, such as can be produced by cryo-EM, toward identifying binding interactions between molecules, other types of particles, or any combination thereof.

A method of imaging an interaction of a particle and a fragment in a sample includes applying a template to one or more images of a sample comprising a particle and a fragment. The template comprises a three-dimensional representation of the particle at a resolution of higher than about 1/8 reciprocal Angstroms and is produced by data independent of data provided in the one or more images. The fragment is not represented in the template. The method further includes producing a similarity image comprising a pixel- wise representation of a distance metric between the template and the one or more images. The distance metric enables detection of at least a portion of the particle or fragment. The method further includes applying a probability metric, such as a threshold, to the similarity image to distinguish positive detections from noise and producing a representation of a volume as a function of the positive detections. The representation of the volume includes elements representing an interaction between the particle and the fragment. A high-resolution image of the interaction can thereby be produced.

The representation of the volume can include elements representing at least one of a location and an orientation of the fragment with respect to the particle. The representation of the volume can include elements representing molecular interactions of the fragment and the particle, such as, for example, representations of coordinated water molecules.

The method can further include producing a representation of a difference volume as a function of the template and the representation of the volume produced, the difference volume including elements representing the at least one fragment. Applying the probability metric to the similarity image can include iteratively applying one or more probability metrics, or thresholds, to one or more similarity images and producing one or more cumulative similarity images comprising positive detections. The images can be cryogenic electron microscopy images. A resolution of the volume produced can be higher than about ⅕ reciprocal Angstroms.

The template can include a plurality of two-dimensional representations of the particle, can include a three-dimensional representation of the particle, or a combination thereof. The template can be generated from at least one of a density map of the particle, a set of atomic coordinates of the particle, a predicted three-dimensional structure of the particle, or a combination thereof.

Applying the template to the one or more image can include performing at least one of pattern-recognition, rigid-body search, and machine learning.

The sample can be one that comprises the particle and the fragment without extraneous cellular material (e.g., a purified sample). Alternatively, the sample can be one that contains extraneous cellular material (e.g., a non-purified sample, or an in vivo sample)

A method of performing drug discovery includes imaging interactions of at least one particle and a plurality of fragments. The method further includes detecting, from the representation of the volume produced, a binding interaction between the at least one particle and at least one of the plurality of fragments and identifying the at least one of the plurality of fragments as a candidate drug fragment based on the binding interaction detected.

A system for imaging an interaction of a particle and a fragment in a sample includes a processor configured to apply a template to one or more images of a sample comprising a particle and a fragment. The template includes a three-dimensional representation of the particle at a resolution of higher than about ⅛ reciprocal Angstroms and is produced by data independent of data provided in the one or more images. The fragment is not represented in the template. The processor is further configured to produce a similarity image comprising a pixel-wise representation of a distance metric between the template and the one or more images, enabling detection of at least a portion of the particle or fragment. The processor is further configured to apply a probability metric to the similarity image to distinguish positive detections from noise and produce a representation of a volume as a function of the positive detections. The representation of the volume includes elements representing an interaction between the particle and the fragment.

As used herein “a processor” can include one or more processors, each processor configured to perform at least a portion of the provided imaging procedure.

The representation of the volume produced can include elements representing at least one of a location and an orientation of the fragment with respect to the particle and/or elements representing molecular interactions of the fragment and the particle. Molecular interactions represented in the volume can include representations of coordinated water molecules.

The processor can be further configured to produce a representation of a difference volume as a function of the template and the representation of the volume produced, the difference volume including elements representing the at least one fragment.

The processor can be further configured to apply one or more probability metrics, or thresholds, to one or more similarity images and produce one or more cumulative similarity images comprising positive detections.

The one or more images can be cryogenic electron microscopy images. A resolution of the volume produced can be higher than about ⅕ reciprocal Angstroms.

The template can include a plurality of two-dimensional representations of the particle. The template is generated from at least one of a density map of the particle, a set of atomic coordinates of the particle, a predicted three-dimensional structure of the particle, or a combination thereof. The processor can be further configured to generate the template.

The processor can be configured to perform at least one of pattern-recognition, rigid-body search, and machine learning to apply the template and/or generate the template.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating a conventional workflow for cryo-EM image processing as compared with an improved workflow that can significantly improve processing time. Conventional workflow on left panel is as provided by Bai, X-C. 2021. 3D classification of structurally heterogeneous particles. In: Single-particle Cryo-EM of Biological Macromolecules, Glaeser, Nogales, Chiu (Eds). IOP Publishing, Bristol, UK.

FIG. 2 is a flow diagram illustrating an example method of imaging an interaction of a particle and a fragment in a sample, such as with cryo-EM.

FIG. 3 is a flow diagram illustrating an example cryo-EM imaging process.

FIG. 4A is an image from a cryo-EM dataset of E. coli β-galactosidase (Bgal) bound to phenylethyl β-D-thiogalactopyranoside (PETG). Dataset is as provided in EMPIAR-10644, Saur M, Hartshorn M J, Dong J, Reeks J, Bunkoczi G, Jhoti H, Williams P A. 2020. Fragment-based drug discovery using cryo-EM. Drug Discov Today 25:485-490.

FIG. 4B is an example of a similarity image produced from 2DTM.

FIG. 4C is an example of a model produced from the data of FIGS. 4A and 4B, where approximately twenty copies of an enzyme and their orientations are visible.

FIGS. 5A-5D illustrate results of an example method of imaging an interaction of a particle and a fragment in a sample. FIG. 5A is an image of the 3D structure produced with the example method, showing a reconstruction of Bgal from 2DTM coordinates using images from EMPIAR-10644, with a Bgal crystal structure (PDB-1DP0) (Juers D H, Jacobson R H, Wigley D, Zhang X-J, Huber R E, Tronrud D E, Matthews B W. 2000. High resolution refinement of β-galactosidase in a new crystal form reveals multiple metal-binding sites and provides a structural basis for α-complementation. Protein Sci 9:1685-1699) as a template, and a 10 Angstrom sphere around the PETG ligand omitted. FIG. 5B is a 2D slice through the reconstruction in FIG. 5A including the region deleted from the density, showing no obvious discontinuity in the density. FIG. 5C is a view of the density in FIG. 5A near the PETG ligand, with regions within 1.8 Angstrom of the template model highlighted in red. Gray indicates density of Bgal outside of the template, purple indicates density consistent with the position of PETG and blue indicates additional density that likely represent water molecules. FIG. 5D is a stick diagram made from PDB-1DP0, showing the locations of the atoms in the template used for template matching.

FIGS. 6A-6D illustrate results of an analysis performed by a conventional single-particle workflow involving manual steps, showing a reconstruction of Bgal published by Saur M, Hartshorn M J, Dong J, Reeks J, Bunkoczi G, Jhoti H, Williams P A. 2020. Fragment-based drug discovery using cryo-EM. Drug Discov Today 25:485-490. FIG. 6B is a 2D slice through the reconstruction in FIG. 6A including the region deleted from the density, showing no obvious discontinuity in the density. FIG. 6C is a view of the density in FIG. 6A near the PETG ligand, with regions within 1.8 Angstrom of the template model highlighted in red. Gray indicates density of Bgal outside of the template, purple indicates density consistent with the position of PETG and blue indicates additional density that likely represent water molecules. FIG. 6D is a stick diagram made from PDB-1DP0, showing all atoms annotated in the crystal structure, including those omitted before generating the 2DTM template.

FIG. 7A illustrates results of an example method of imaging an interaction of a particle and a fragment in a sample, with a color map indicating the obtained resolution (in Angstrom) in the reconstruction shown in FIG. 5A.

FIG. 7B is an expanded view of a portion of FIG. 7A, where a binding pocket is visible.

FIG. 7C is a graph of an average resolution of 2.2 Angstrom, as measured by the Fourier Shell Correlation, of the complex of FIGS. 5A, 7A and 7B.

FIG. 8A is an example of a particle and a fragment visualized using the provided method.

FIG. 8B is the same model in FIG. 8A, color coded by the local resolution.

FIG. 8C shows the drug cycloheximide, an example fragment, visualized binding to the ribosome in the cell.

FIG. 8D shows additional unexpected fragments binding to the particle.

FIG. 9A shows a particle and large protein fragment solved using the provided method, color coded by local resolution.

FIG. 9B illustrates the same particle and fragment as in FIG. 9A, with the particle color coded in pink to clearly show the protein fragment.

FIG. 9C is a closer view of the density showing clear density for the protein fragment (red) in addition to the particle (blue) of FIGS. 9A and 9B.

FIG. 10A illustrates a template representing a particle lacking a fragment corresponding to a nucleotide.

FIG. 10B illustrates a reconstruction, showing that the density for the fragment that was not present in the template of FIG. 10A is recovered in the reconstruction.

FIG. 10C illustrates a template representing a particle lacking a fragment corresponding to an amino acid fragment.

FIG. 10D illustrates a reconstruction, showing that the density for the fragment that was not present in the template of FIG. 10C is recovered in the reconstruction.

FIG. 10E illustrates a template representing a particle lacking a fragment corresponding to an amino acid fragment.

FIG. 10F illustrates a reconstruction, showing that the density for the fragment that was not present in the template of FIG. 10C is recovered in the reconstruction.

FIG. 11 is a schematic view of a computer network environment in which the example embodiments presented herein may be implemented.

FIG. 12 is a block diagram illustrating an example computer node of the network of FIG. 11.

### DETAILED DESCRIPTION

A description of example embodiments follows.

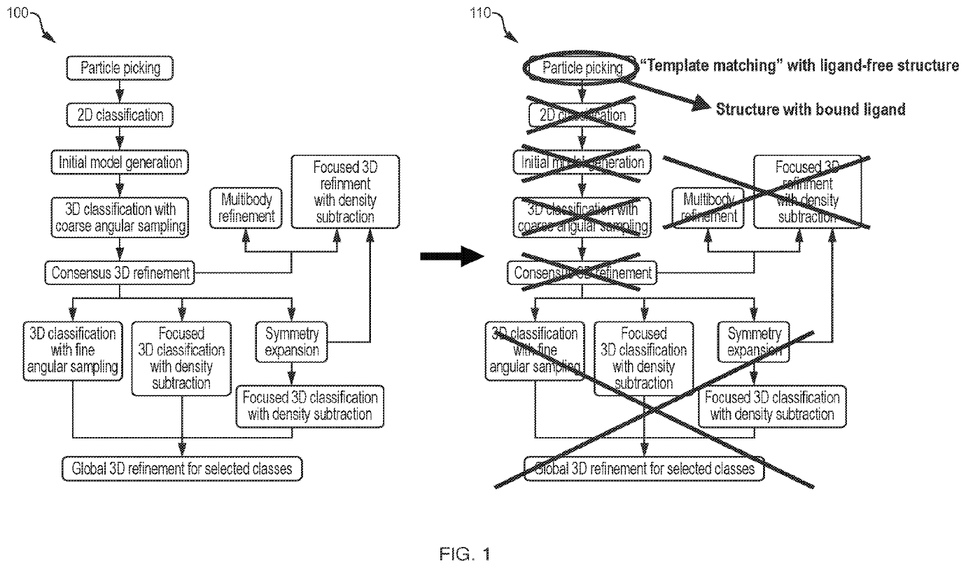

Electron cryo-microscopy (cryo-EM) and an image processing technique called single-particle analysis have been used to determine three-dimensional structures of complexes of interest. The structures can show where exactly a fragment (e.g., a ligand) binds and what chemical interactions in the binding pocket determine binding affinity and specificity. Single-particle cryo-EM workflow involves many steps, including: sample purification and preparation for cryo-EM imaging, data collection on the electron microscope, processing of the images, and interpretation of the three-dimensional reconstruction of the target complex. A conventional cryo-EM workflow is shown in FIG. 1 (left side, taken from Bai, X-C. 2021. 3D classification of structurally heterogeneous particles. In: Single-particle Cryo-EM of Biological Macromolecules, Glaeser, Nogales, Chiu (Eds). IOP Publishing, Bristol, UK.). In some cases, atomic resolution can be obtained. For biologically active molecules, the results of this workflow can provide detailed information about molecular mechanisms and interactions between molecular ligands and binding pockets, possibly including a network of coordinated water molecules. A number of facilities across the U.S. offer cryo-EM services. Commercial and non-profit entities can supply a purified sample and receive cryo-EM data that requires further processing. Image processing services are not routinely offered and usually need to be done by the requesting entity. The current image processing workflow involves many steps and requires an expert to annotate data and make decisions (FIG. 1, left side). These steps are repeated for each and every new fragment that is being studied. The complexity and required input from experts make image processing prone to error and, furthermore, limit the throughput achievable using the current single-particle cryo-EM workflow.

Methods and systems are provided which reduce the complexity, time, and resources for performing cryo-EM image processing. The systems and methods provide for an improvement and modification of image processing techniques involving 2D template matching (2DTM). A comparison of conventional cryo-EM processing 100 with an example, improved method 110 involving template matching is shown in FIG. 1.

The 2DTM techniques have been applied within the context of studying molecules inside cells (in situ), as further described in Rickgauer et al., “Single-protein detection in crowded molecular environments in cryo-EM images,” eLife 2017 and in Lucas et al., “Locating Macromolecular Assemblies in Cells by 2D Template Matching with cisTEM,” eLife 2021, the entire teachings of which are incorporated herein by reference.

The provided systems and methods include 2DTM image processing applied to purified samples that are typically studied by the cryo-EM single particle workflow described above. The provided methods can replace the complex image processing workflow with a black-box type workflow that can be completely automated, thereby removing the current bottleneck in single-particle cryo-EM. The provided methods further differ from existing cryo-EM single particle workflow methods in that high-resolution structures (i.e., templates) are included.

As used herein, the term “high-resolution” with respect to a template providing representation of a particle means a resolution of higher than about ⅛ reciprocal Angstroms.

To obtain a high-resolution structure with a bound fragment (e.g., a bound ligand or drug), the 2DTM workflow can be initiated with a three-dimensional model of the particle (e.g., a ligand-free structure) as the template. The result can then be a three-dimensional structure representative of the bound fragment. A fragment-free template can be obtained from high-resolution structures provided by other experiments or sources, for example, the Protein Data Bank, which contains thousands of entries, can provide for high-resolution particle structures. Particles can include one or more pharmacologically relevant targets, such as G-protein coupled receptors (GPCRs). Advances in structure prediction software have also recently become accurate enough to be used as templates. Templates can be or include, for example, a density map, a set of atomic coordinates, a library of two dimensional projections of a particle, and/or a structure prediction. The template provides a three-dimensional representation of the particle without the one or more fragments under test.

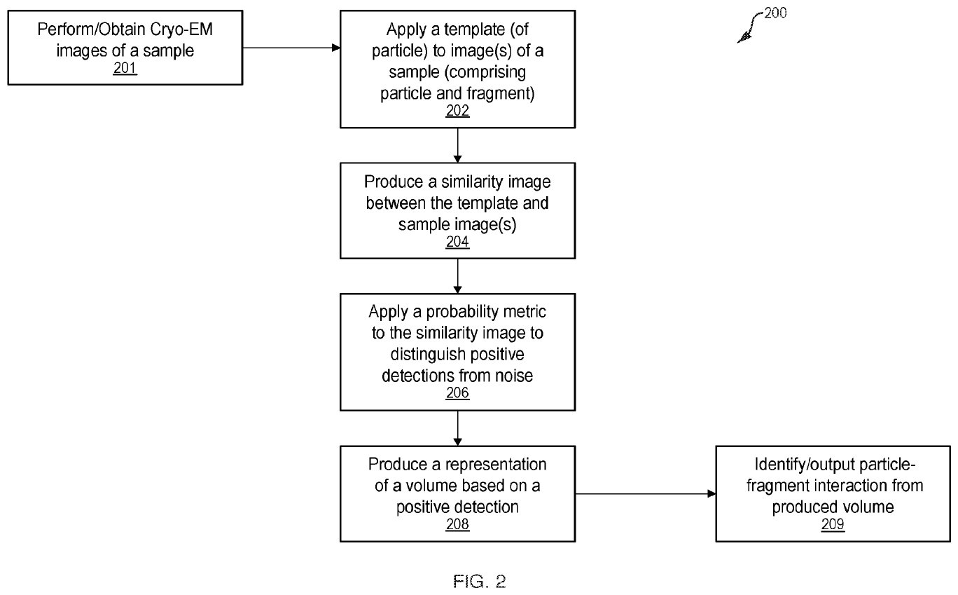

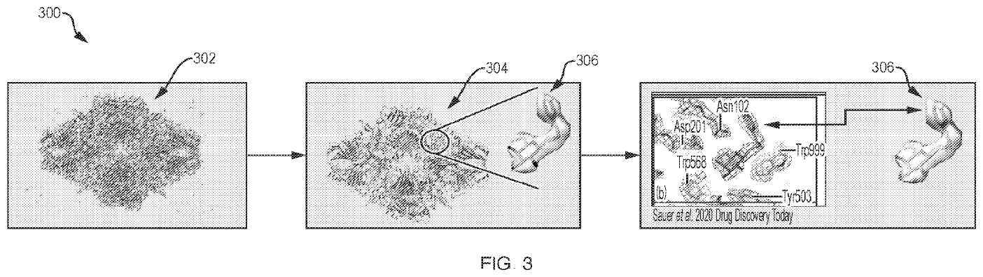

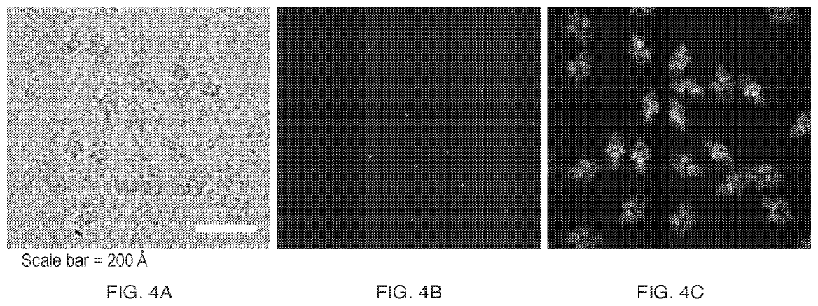

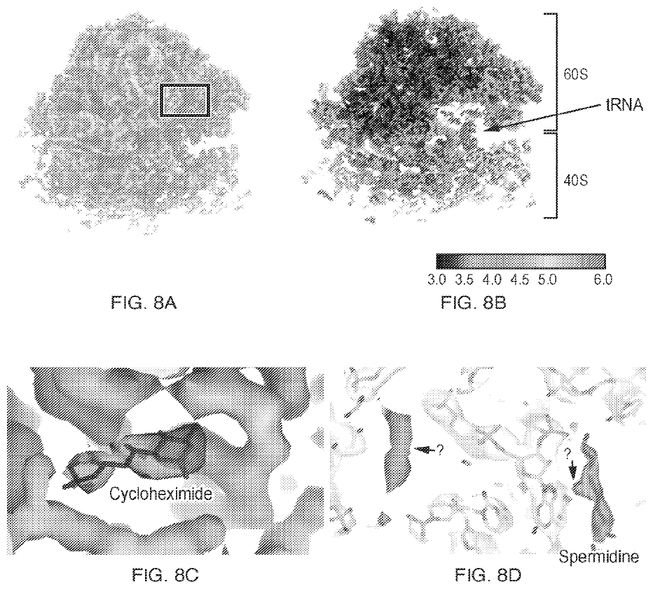

An example method 200 of imaging an interaction of a particle and a fragment in a sample is shown in FIG. 2. The method can be applied to a cryo-EM imaging process 300, as shown in FIG. 3. Initially, one or more images (e.g., cryo-EM image) of a sample are obtained (201, FIG. 2). The sample can be, for example, a purified sample containing one or more particles and one or more fragments. Alternatively, the sample can be a non-purified sample, for example, contain extraneous cellular material. The method 200 includes applying a template (e.g., template 302, FIG. 3) to the one or more images (202, FIG. 2). The template can include a three-dimensional representation of the particle at a resolution of higher than about ⅛ reciprocal Angstroms, and it can be produced by data independent of data provided in the one or more images. The fragment is not represented in the template. The method further includes producing a similarity image (e.g., FIG. 4B) comprising a pixel-wise representation of a distance metric between the template and the one or more images (204, FIG. 2), the distance metric enabling detection of at least a portion of the particle or fragment (e.g., fragment 306, FIG. 3). The template can be used in the formation of a difference map. For illustration purposes, a difference map is represented in FIG. 3 with respect to the template indicated by the dark shaded (blue) portions and light shaded (gray) portions of map 302, where the dark shaded (blue) portions represent portions of the template 304, and the light shaded (tan) portions representing portions of the fragment 306 that are not present in the template. Optionally, the method includes applying a threshold or other probability metric to the similarity image to distinguish positive detections from noise (206, FIG. 2). The method further includes producing a representation of a volume as a function of the positive detections (208, FIG. 2), the representation of the volume including elements representing an interaction between the particle and the fragment (see, e.g., FIGS. 8A-8C). A particle-fragment interaction can thus be identified from the produced volume (209, FIG. 2).

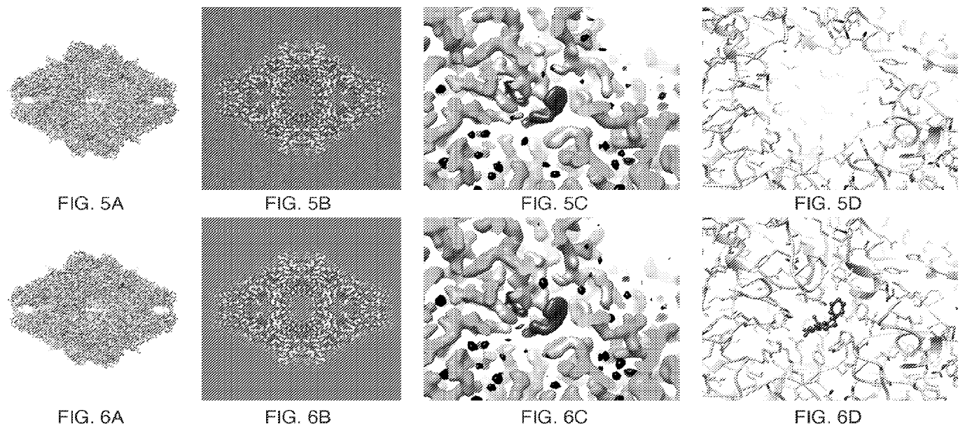

A representation of the volume produced can include elements representing at least one of a location and an orientation of the fragment with respect to the particle, elements representing molecular interactions of the fragment and the particle, and/or representations of coordinated water molecules (see, e.g., FIGS. 5C, 7B, 8B-8D, and 9C).

A representation of a difference volume (or a difference map) as a function of the template and the representation of the volume produced can be provided (see, e.g., FIGS. 5C, 5D, and 8C). The difference volume can include elements representing the at least one fragment.

Applying a threshold to a similarity image can include iteratively applying one or more thresholds to one or more similarity images and producing one or more cumulative similarity images comprising positive detections.

The images can be cryogenic electron microscopy images (see, e.g., FIG. 4A). A resolution of the volume produced can be higher than about ⅕ reciprocal Angstroms (see, e.g., FIG. 8B).

A template can include or be produced from a plurality of two-dimensional representations of the particle, generated from at least one of a density map of the particle, a set of atomic coordinates of the particle, a predicted three-dimensional structure of the particle, or a combination thereof. Two-dimensional template matching can be performed as described in Lucas et al., “Locating Macromolecular Assemblies in Cells by 2D Template Matching with cisTEM,” eLife 2021, the entire teachings of which are incorporated herein by reference.

Applying the template to the one or more images can include performing at least one of pattern-recognition, rigid-body search, and machine learning.

The provided methods and systems can reduce or eliminate a need for experts running the image processing pipeline. The provided methods and systems can also reduce the amount of data that need to be collected, reduce the level of sample purity required for successful analysis, and, depending on the sample, may also increase the resolution (i.e., level of detail) visible in the final three-dimensional structures generated by the new method. The new workflow can make drug discovery much more efficient and more accessible. With 2DTM, the current image processing bottleneck and requirement of an expert can be addressed with an investment into computer equipment and software implementing the new method. The new workflow can also be used to visualize other types of bound fragments, such as antibodies bound to pharmacological or pathogen targets.

The systems and methods provided can be used, for example, to analyze a sample comprising one or more particles (e.g., pharmacological targets, such as receptor proteins) and one or more fragments (e.g., small molecule drug candidates or antibodies) to determine which fragments bind to which particles, where such binding interactions occur, and/or interaction characteristics of the bound fragment and particle (e.g., binding orientations, binding affinity, etc.). The particles and fragments may or may not be known to interact. For example, with a template of a resolution of higher than about ⅛ reciprocal Angstroms, or higher than about ⅙ reciprocal Angstroms, the provided systems and methods can produce a volume representing interaction between the particle and the fragment with a resolution that can reveal coordinated water molecules of the structure.

The provided systems and methods can enable multiplexing via template matching, a process that is not practicably performable with existing single-particle cryo-EM processing methods. For example, a sample can contain a plurality of fragments and/or a plurality of particles.

Cryo-EM images have low signal to noise, and identification of particles of interested can be difficult. This can be particularly true of small complexes that have low contrast and are difficult to identify by eye. 2DTM can localize complexes with high precision even with background. However, reconstruction using coordinates identified using a high-resolution template can reproduce the template by partial matching with noise, making interpretation of high-resolution features unreliable. The provided methods provide for baited reconstruction as a new approach to take advantage of the precision of 2DTM while avoiding template bias.

Cryogenic electron microscopy (cryo-EM) has revolutionized structural biology, rapidly increasing the number of available molecular structures. The wealth of structural information in databases such as the Protein Data Bank (PDB) can enable training of machine learning algorithms to predict the structures of proteins from their amino acid sequences alone, generating a predicted model for known protein sequences. Together with the PDB, biologists now have access to an experimentally determined or predicted structure for almost all known proteins. The focus of structural biology is therefore beginning to shift from determining the structures of individual macromolecules in isolation, to understand how they function together to achieve myriad cellular functions.

An approach to precisely localize and characterize complexes in cells using pre-existing structures is provided. It is shown that new structures that were not part of a template can be recovered by averaging the particles localized with 2DTM. In the provided methods, a template can be used to localize a molecule that acts as a “bait” to characterize new features at high-resolution in vitro and in vivo. Baited reconstruction can validate the recovery of high-resolution features in reconstructions generated by averaging 2DTM coordinates. Baited reconstruction can be considered analogous to a “pull down” assay in molecular biology, wherein a “bait” molecule is used to capture and identify novel interacting “prey”. This strategy is distinct from prior structure determination strategies because it makes use of a high-resolution template, traditionally avoided to prevent introducing artefacts, e.g.: obtaining “Einstein from noise”. Baited reconstruction leverages the advantages of precise targeting with a high-resolution template, while avoiding the pitfalls by focusing on regions omitted or external to the template.

A 2D template matching (2DTM) approach is provided that can identify target molecules and complexes in cryo-EM images of cells and cell sections, using single images of nominally untilted specimens. This approach can be used in combination with 3D template matching (3DTM) to identify targets in tomograms collected from the same areas imaged for 2DTM to achieve improved overall precision and sensitivity of target detection. The targets detected by 2DTM can be used to calculate 3D reconstructions showing novel details not present in the template. This is possible because for every detected target, 2DTM can also determine the target's x,y location in the image, three Euler angles and image defocus, i.e., parameters that can be needed to calculate a single-particle reconstruction. Using this approach, extra density in a rotavirus capsid and for the small ribosomal subunit (SSU) was revealed, as well as structural differences between M. pneumoniae and B. subtilis large ribosomal subunits (LSUs). Interpretation of reconstructions obtained from 2DTM targets can be limited by template bias but, as further described herein, it has been shown that template bias does not prevent the discovery of new structural features. 2DTM can therefore be used to study the structure of targets that would be too small to identify on their own, as long as they bind or are otherwise rigidly attached to a larger target that can be located by 2DTM.

As further described in the Exemplification section herein, a study was performed to assess the resolution that can be obtained in the regions omitted in the template. A published single particle dataset of beta-galactosidase was analyzed using 2DTM, and a newly collected dataset of 60 S LSUs detected in images of S. cerevisiae lamellae. In both cases, high resolution in areas of the reconstruction that were omitted in the template was shown, demonstrating the utility of 2DTM for structure discovery.

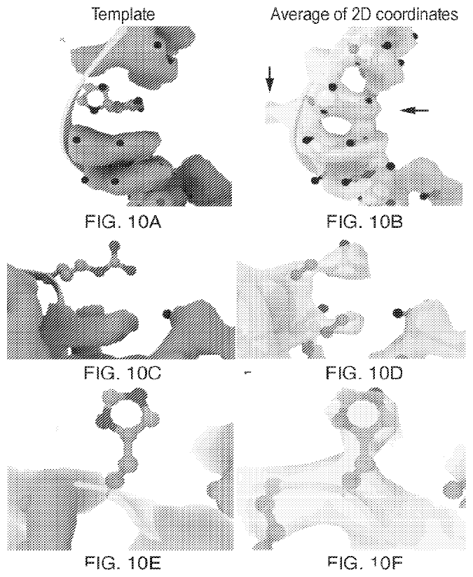

In particular, it was shown that baited reconstruction with 2DTM can reveal high resolution details outside of the template. Using a previously published single particle dataset, the interactions of specific sidechains with a ligand drug were observed. Using particles localized in FIB-milled yeast lamellae specific binding of the drug CHX and polyamides to the ribosome in cells was observed using fewer particles than with subtomogram averaging. It was shown that omission of single proteins or single residues from the template and baited reconstruction can be used to recover high-resolution features in cells without template bias (see FIGS. 10A-10F). Baited reconstruction can leverage the wealth of structureomic data to approach biological and pharmacological questions in vitro and in vivo.

One of the most direct applications of this approach is to drug discovery. During the drug development pipeline, potentially thousands of variants of a lead compound are tested relative to a single target protein. Determining the structures of each in complex with its protein partner is time-consuming, laborious and expensive. The methods and systems provided here can be used to streamline this process substantially.

The ribosome is a major target of antibiotic and anticancer drugs. It has been demonstrated that baited reconstruction with 2DTM can reveal drug-ribosome interactions directly in cells. This approach can be used to characterize the mechanism of action of antibiotic drugs directly in cells. Since 2DTM does not require purification, interactions with other cellular complexes can also be investigated.

Baited reconstruction is substantially faster and a more streamlined pipeline for in situ structure determination relative to cryo-ET and subtomogram averaging. Current pipelines for in situ structure determination using cryo-ET and sub-tomogram averaging are time consuming and require expert knowledge to curate an effective pipeline. A class of 17,890 particles was identified to achieve 3.5 Angstrom resolution, as further described in Tegunov et al., Multi-particle cryo-EM refinement with M visualizes ribosome-antibiotic complex at 3.5 Å in cells, Nat Methods 18, 186-193 (2021). As further described in the Exemplification section herein, results demonstrate that it is possible to use the particle locations and poses from 2DTM to achieve a 3.2 Angstrom resolution reconstruction from ˜2-fold fewer particles without classification. Focused classification to identify sub-populations can further improve the resolution of in situ reconstructions from 2DTM. This shows that it is not necessary to use tomography to generate high-resolution reconstructions of macromolecular complexes in cells, vastly reducing the time and expense for structure determination in cells.

As used herein, the term “baited reconstruction” means reconstruction of a structure (e.g., a molecular structure, such as a particle or fragment) based on its attachment of image features (of an image of a sample containing particles or fragments comprising the structure) to features of a template of the structure. Baited reconstruction can include formation of a similarity image.

By determining the molecule pose to high accuracy fewer particles are required to achieve high-resolution structures. In the cell the major limitation for in situ structure determination is the low concentration of most cellular complexes. By reducing the number of particles needed to achieve high-resolution reconstructions in cells, baited reconstruction with 2DTM can provide for the determination of structures of less abundant complexes in cells. Advantages for in situ applications include: higher resolution with fewer particles; lamellae, less defects from distortion and charging; and, an ability to generate reconstructions of less abundant complexes.

Baited reconstruction using 2DTM can also facilitate the characterization of new biology at high resolution. For example, how a newly identified disease-relevant mutation changes the structure of the active site of a protein or the nature of a protein-protein interface can be determined. Currently, to answer these questions using single particle cryo-EM requires identifying the particles, and iteratively averaging to generate a high-resolution reconstruction into which an existing model can be fit.

### Example Digital Processing Environment

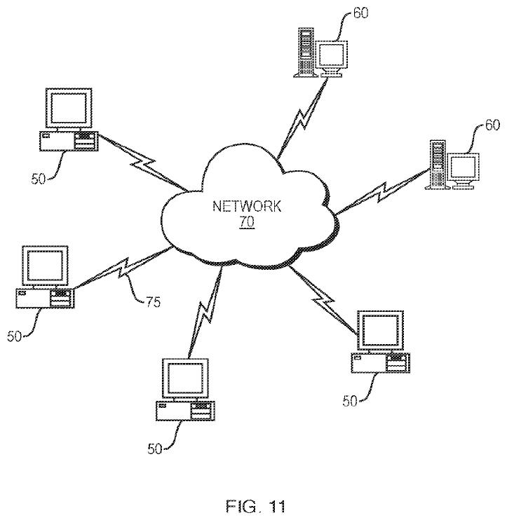

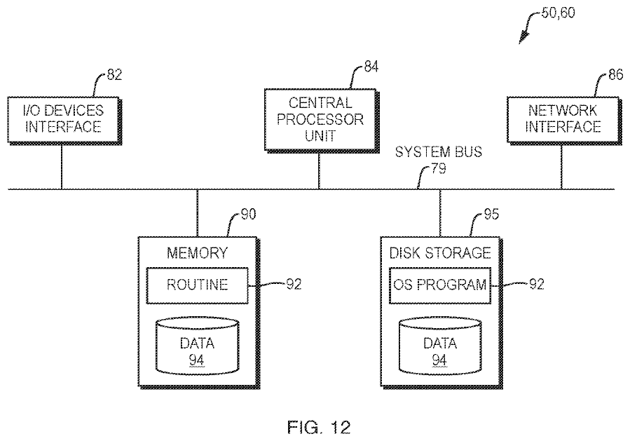

FIG. 11 illustrates a computer network or similar digital processing environment in which the present embodiments may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

FIG. 12 is a diagram of the internal structure of a computer (e.g., client processor/device 50 or server computers 60) in the computer system of FIG. 12. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. 11). Memory 90 provides volatile storage for computer software instructions 92 and data 94 used to implement many embodiments (e.g., the example method 200 of FIG. 2). Disk storage 95 provides non-volatile storage for computer software instructions 92 and data 94 used to implement many embodiments. Central processor unit 84 is also attached to system bus 79 and provides for the execution of computer instructions.

In the context of FIG. 11, the computer 50, 60 can be used to acquire (via, for example, interface 82) images of a sample comprising a particle and a fragment, such as cryo-EM images, and data providing for the formation of a template. Components of the system include memory 90, 95 and a processor 84. The memory 90, 95 can store data providing for the execution of processes described herein, including, for example, data representing templates, 2D and 3D models, similarity images, difference maps, and produced volumes. The processor 84 can include one or more processors, which can be configured to, for example, form a template, apply a template to an image of a sample, produce a similarity image, apply a probability metric to a similarity image, produce a difference map, and produce a representation of a volume as a function of the positive detection, including elements representing an interaction between the particle and the fragment.

In one embodiment, the processor routines 92 and data 94 are a computer program product (generally referenced 92), including a computer readable medium (e.g., a removable storage medium such as one or more DVD-ROM's, CD-ROM's, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the program product 92 may be implemented as Software as a Service (SaaS), or other installation or communication supporting end-users.

The generation of a template, the application of a template an image, such as a cryo-EM image, and/or the formation of a similarity image can include performing at least one of pattern-recognition, rigid-body search, and machine learning. The identification of a particle and/or fragment, for example, as a candidate drug, can also include performing at least one of pattern-recognition, rigid-body search, and machine learning.

Machine learning is a method of teaching computers to learn and make decisions on their own, without explicitly being programmed to perform a specific task. It involves feeding a large amount of data into a computer program, which then uses statistical analysis to identify patterns and relationships within the data. The goal is to enable the program to make predictions or decisions based on these patterns and relationships, without being explicitly told how to do so.

Neural networks are a type of machine learning algorithm that are inspired by the structure and function of the human brain. They consist of layers of interconnected “neurons,” sometimes called nodes, which process and transmit information. Each neuron receives input from other neurons, processes it, and passes it on to other neurons in the next layer.

The layers in a neural network refer to the layers of interconnected neurons. There are typically multiple layers in a neural network, with the input layer receiving the raw data and the output layer producing the final prediction or decision. Between the input and output layers, there are one or more hidden layers, which process the data and pass it on to the next layer.

By training a neural network on a large dataset, the connections between neurons (called “weights”) can be adjusted in order to improve the network's ability to make predictions or decisions. To train a neural network, the data is fed through the network and the output is compared to the desired result. If the output is not accurate, the weights are adjusted in order to reduce the error. This process is repeated multiple times, with the network continually adjusting the weights in order to improve its accuracy. Once the network has been trained, it can be used to make predictions or decisions on new data, based on the patterns and relationships it has learned from the training data.

### EXEMPLIFICATION

### Example 1. Beta-Galactosidase Ligand Binding Pocket

To show the potential of 2DTM to reveal new structural details at high resolution, we analyzed a published single-particle cryo-EM dataset of E. coli β-galactosidase (Bgal) bound to phenylethyl β-D-thiogalactopyranoside (PETG). The dataset was used previously to calculate a 2.2-Angstrom reconstruction (EMDB-10574) that displays density for a number of specifically bound water molecules in the structure, including in the PETG binding pocket. The authors also built an atomic model into the high-resolution map (PDB-6TTE). However, for the present template, an atomic model of ligand-free Bgal determined by X-ray crystallography at 1.7 Angstrom (PDB-1DP0) was used. Using a model that was not built into a map derived from the data analyzed by 2DTM aids demonstration of 2DTM as a tool that can make use of atomic models experimentally unrelated to the data being analyzed.

To demonstrate high resolution in areas omitted in the template, atoms in the vicinity of all D2 symmetry-related ligand binding pockets were removed, within a 10-Angstrom radius centered on the side chain amide nitrogen atom of asparagine 102 (in PDB-1DP0). The truncated atomic model was used to generate a template with cisTEM's simulator using a pixel size of 0.672 Angstrom. The pixel size is slightly smaller than published for this dataset (0.68 Angstrom) and is based on fitting the 1.7-Angstrom X-ray structure into the published 2.2-Angstrom cryo-EM map of PETG-bound Bgal, and adjusting the pixel size of the map to achieve optimal density overlap between model and map in UCSF Chimera. Micrograph movie data were downloaded from the EMPIAR database (EMPIAR-10644) and processed with the cisTEM image processing package using Unblur to align and average the exposure-weighted movie frames, and CTFFIND4 to determine image defocus values. Four of the 562 micrographs were discarded based on lack of clear CTF Thon rings or ice crystal contamination. The remaining 558 images were processed using cisTEM's template matching implementation, yielding 59,259 targets with 2DTM SNRs above a threshold of 7.3 (FIGS. 4A-4C), a standard threshold used to limit the number of false positives to one per micrograph. To reduce the particles to a number closer to the final dataset used to calculate the 2.2-Angstrom cryo-EM map in (49,895), and to include only the “best” particles, targets were limited to those with 2DTM SNRs above 9.0 and obtained a final dataset of 55,627 particles.

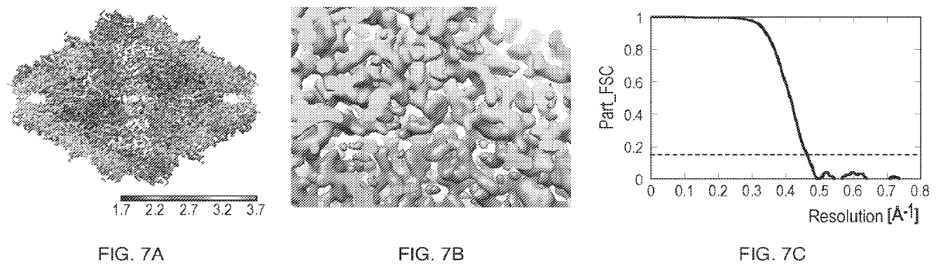

The identified 55,627 targets were extracted together with their template-matched x,y positions, Euler angles and CTFFIND4-derived defocus values using prepare_stack_matchtemplate, and the particle stack and alignment parameters were imported into cisTEM as a refinement package for further single particle processing. The Fourier Shell Correlation (FSC) for the initial reconstruction calculated from the template-matched alignment parameters indicated a resolution of 2.4 Angstrom (FSC=0.143, ref Rosenthal 2003). One cycle of defocus and beam tilt refinement was performed against the template, followed by a refinement of alignment parameters and another cycle of defocus and beam tilt parameters, while keeping the refinement resolution limit of 3.0 Angstrom. The final reconstruction (FIGS. 5A-5D and 6A-6D) displayed a resolution according to the FSC of 2.2 Angstrom (FIGS. 7A-7C).

Peaks corresponding to detected targets are clearly visible (FIG. 4B). The average 2DTM SNR for this dataset was 11.6, and a maximum of 16.3, which is in the range of what is expected for a 465-kDa target. The refined reconstruction shows clear density for PETG and water molecules in the ligand binding pocket that were omitted in the template (FIGS. 5C and 6D). Comparison of this reconstruction with the published map (FIGS. 6A-6D) suggests that they are virtually identical and that there is little or no evidence of template bias in the 2DTM reconstruction. An assessment of the local resolution using Phenix further indicates a resolution of about 1.8 Angstrom in the binding pocket, consistent with the clear density for water.

### Example 2. Baited Reconstruction Visualizes Ribosomes in Cells

To investigate the capacity for 2DTM to generate reliable high-resolution reconstructions in cells, 32 images of 4 FIB-milled lamellae generated from S. cerevisiae cells treated with the translation inhibitor cycloheximide (CHX) were collected. Identified were 10,857 large ribosomal subunits with 2DTM in the cytoplasm. The 2DTM coordinates were averaged directly without further positional or orientational refinement to generate a 3D reconstruction with a nominal resolution of 3.2 Angstrom (FSC=0.143) (FIG. 8A-8B, FIGS. 11A-11B). As previously reported, density consistent with the small ribosomal subunit (SSU) and tRNAs that did not derive from the template was found. Local resolution estimation showed that parts of the SSU could be resolved to <4 Angstrom. The SSU is flexible and shows considerable positional heterogeneity relative to the LSU. Therefore, this value is likely an underestimate of the potential attainable resolution by averaging 2DTM coordinates in cells. Also, tRNAs in the A/A and P/P state were observed. Since additional classification was not performed, the tRNAs reflect an average of all tRNAs binding the ribosome. CHX stalls the ribosome in the classical non-rotated state, therefore this state is likely over-represented, however, the tRNAs will still be a mixture depending on the codon at which the ribosome has stalled. Continuous density in the E-site in the map filtered to 3.2 Angstrom was not observed.

### Example 3. Visualization of Drug-Target Interactions in Cells

Drug-target interactions can be visualized at high-resolution in vitro with cryo-EM and X-ray crystallography. However, it is unclear whether this captures the binding site in vivo and may miss additional weak interactions that are lost in purification. Visualizing drug target interactions in cells is therefore an important goal. Additional density in the ribosomal E-site that was not present in the template that is consistent with the position of cycloheximide in a previously published crystal structure (FIG. 8C) was observed. The density was sufficiently well resolved to dock CHX and provide in vivo confirmation for the position and orientation of CHX binding in the E-site.

Several key differences between the model built from the in vitro CHX-bound structure and the in situ CHX-bound structure were noted (FIG. 8D). Whether spermidine binds as part of the translation cycle and has been trapped by CHX-binding or whether stalling of translation allowed for spermidine to bind is unclear. Baited reconstruction with 2DTM can be used to further probe the function of polyamides to regulate translation in vivo.

Baited reconstruction using the large ribosomal subunit as a template model allowed for the visualization of the binding of small molecules such as drugs and lipids within cells. This demonstrates the power of baited reconstruction to reveal biologically relevant features that would only be evident at high resolution.

### Example 4. Omitting Proteins Reveals High Resolution Features Without Template Bias

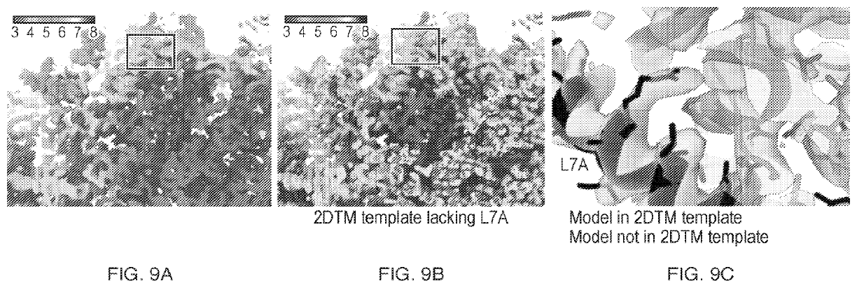

The local resolution of parts of the LSU were measured at ˜3 Angstrom, however, this region overlapped with the template and therefore the resolution measure may be unreliable. To assess the resolution in this region ribosomes were re-located using a template that lacked the ribosomal protein L7A. Since this protein was not present in the template, any density in this region cannot be due to template bias. We found that the local resolution of L7A was indistinguishable from the surrounding density and showed varying local resolution from 3.2 to 4.5 Angstrom. The density was sufficiently well resolved to observe side chains in regions that were lacking from the template (FIGS. 9A-9C). Therefore, baited reconstruction with 2DTM coordinates can be used to generate high-resolution reconstructions in cells free from template bias.

To examine the recovery of high-resolution information with single residue precision, a truncated template was generated wherein 51 kDa (˜3% of the template mass) was removed by removing every 20th residue from each chain in the PDB file. Then, 10,843 targets were localized using the same protocol as for the full-length template. The small difference in template mass minimally affected target detection, only 14 targets were missed with minimal deviations in the locations and orientations. A 3D reconstruction was generated using the same protocol as for the reconstruction using particles identified with the full length template. Density corresponding to the side chains that were not present in the template and therefore cannot derive from template bias was found.

### Example 5. Spermidine Binds CHX-Stalled Ribosomes in Vivo

In this study sufficient resolution to visualize the binding of cellular small molecules such as spermidine was obtained. The clear density for spermidine and the absence of density corresponding to eIF5A are consistent with biochemical experiments showing that spermidine inhibits eIF5A binding. Spermidine concentrations have been shown to affect translation termination, stop codon read through, frameshifting and translational fidelity in in vitro translation experiments. Clear density for spermidine was found when averaging all identified LSUs in CHX treated cells, but not in untreated cells. This demonstrates that (1) the in vivo spermidine concentration is at least stoichiometric with the LSU and (2) spermidine is not constitutively bound to the LSU. Therefore, spermidine binds specific sites on the LSU in a regulated manner that is not dependent on concentration alone. Whether spermidine binds and dissociates as a normal part of the translation cycle, or whether it binds once translation has stalled, such as at termination codons or after drug treatment, is unclear. Further work to determine in situ structures representing different states of translation can be performed. This finding highlights the importance of high-resolution in situ structural biology to reveal concentration-independent actions of small molecules.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of imaging an interaction of a particle and a fragment in a sample, comprising:
applying a template to one or more images of a sample comprising a particle and a fragment, the template comprising a three-dimensional representation of the particle at a resolution of higher than about ⅛ reciprocal Angstroms and produced by data independent of data provided in the one or more images, the fragment not represented in the template;
producing a similarity image comprising a pixel-wise representation of a distance metric between the template and the one or more images, the distance metric enabling detection of at least a portion of the particle or fragment;
applying a probability metric to the similarity image to distinguish positive detections from noise; and
producing a representation of a volume as a function of the positive detections, the representation of the volume including elements representing an interaction between the particle and the fragment.

2. The method of claim 1, wherein the representation of the volume produced comprises elements representing at least one of a location and an orientation of the fragment with respect to the particle.

3. The method of claim 1, wherein the representation of the volume produced comprises elements representing molecular interactions of the fragment and the particle.

4. The method of claim 3, wherein the molecular interactions represented comprise representations of coordinated water molecules.

5. The method of claim 1, further comprising producing a representation of a difference volume as a function of the template and the representation of the volume produced, the difference volume including elements representing the at least one fragment.

6. The method of claim 1, wherein applying the probability metric to the similarity image comprises iteratively applying one or more probability metrics to one or more similarity images and producing one or more cumulative similarity images comprising positive detections.

7. The method of claim 1, wherein the one or more images are cryogenic electron microscopy images.

8. The method of claim 1, wherein the resolution of the volume produced is higher than about ⅕ reciprocal Angstroms.

9. The method of claim 1, wherein the template comprises a plurality of two-dimensional representations of the particle.

10. The method of claim 1, wherein the template is generated from at least one of a density map of the particle, a set of atomic coordinates of the particle, a predicted three-dimensional structure of the particle, or a combination thereof.

11. The method of claim 1, wherein applying the template to the one or more images comprises performing at least one of pattern-recognition, rigid-body search, and machine learning.

12. The method of claim 1, wherein the sample is a sample that comprises the particle and the fragment without extraneous cellular material.

13. A method of performing drug discovery, comprising:
imaging interactions of at least one particle and a plurality of fragments according to the method of claim 1;
detecting, from the representation of the volume produced, a binding interaction between the at least one particle and at least one of the plurality of fragments; and
identifying the at least one of the plurality of fragments as a candidate drug fragment based on the binding interaction detected.

14. A system for imaging an interaction of a particle and a fragment in a sample, comprising:
a processor configured to:
apply a template to one or more images of a sample comprising a particle and a fragment, the template comprising a three-dimensional representation of the particle at a resolution of higher than about ⅛ reciprocal Angstroms and produced by data independent of data provided in the one or more images, the fragment not represented in the template;
produce a similarity image comprising a pixel-wise representation of a distance metric between the template and the one or more images, the distance metric enabling detection of at least a portion of the particle or fragment;
apply a probability metric to the similarity image to distinguish positive detections from noise; and
produce a representation of a volume as a function of the positive detections, the representation of the volume including elements representing an interaction between the particle and the fragment.

15. The system of claim 14, wherein the representation of the volume produced comprises elements representing at least one of a location and an orientation of the fragment with respect to the particle.

16. The system of claim 14, wherein the representation of the volume produced comprises elements representing molecular interactions of the fragment and the particle.

17. The system of claim 16, wherein the molecular interactions represented comprise representations of coordinated water molecules.

18. The system of claim 14, wherein the processor is further configured to produce a representation of a difference volume as a function of the template and the representation of the volume produced, the difference volume including elements representing the at least one fragment.

19. The system of claim 14, wherein the processor is further configured to apply one or more probability metrics to one or more similarity images and produce one or more cumulative similarity images comprising positive detections.

20. The system of claim 14, wherein the one or more images are cryogenic electron microscopy images.

21. The system of claim 14, wherein the resolution of the volume produced is higher than about ⅕ reciprocal Angstroms.

22. The system of claim 14, wherein the template comprises a plurality of two-dimensional representations of the particle.

23. The system of claim 14, wherein the template is generated from at least one of a density map of the particle, a set of atomic coordinates of the particle, a predicted three-dimensional structure of the particle, or a combination thereof.

24. The system of claim 14, wherein the processor is further configured to perform at least one of pattern-recognition, rigid-body search, and machine learning to apply the template.

25. The system of claim 14, wherein the sample is a sample that comprises the particle and the fragment without extraneous cellular material.
